(19) United States
(12) Patent Application Publication
(10) Pub. No.: US 2010/0332438 A1
(43) Pub. Date: Dec. 30, 2010

(54) Methods for Predicting Warp of a Wood Product Produced from a Log

(75) Inventors: Mitchell R. Toland, Puyallup, WA (US); Chih-Lin Huang, Bellevue, WA (US); Mark A. Stanish, Seattle, WA (US); Stanely L. Floyd, Enumclaw, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser NR Company, Federal Way, WA (US)

(21) Appl. No.: 12/494,146

(22) Filed: Jun. 29, 2009

(51) Int. Cl. G06N 5/04; G01B 1/00; G06F 17/18; G06F 17/50

(52) U.S. Cl. 706/52; 702/167; 702/179; 703/1

(57) ABSTRACT

The present disclosure relates to methods for predicting warp of a wood product produced from a log. Some embodiments include performing a three dimensional scan of the log to obtain geometric data, using the geometric data to construct a log profile, partitioning the geometric data into geometric components, removing one or more selected geometric components to create one or more residual grid profiles, deriving geometric statistics from the one or more residual grid profiles or from the log profile, and entering the geometric statistics into a model for predicting warp of the wood product. The geometric statistics may include orientation dependent and orientation independent statistics.

### TECHNICAL FIELD

The present disclosure is directed generally to wood products and methods of predicting the warp potential of a wood product based on the geometry and, in some embodiments, other properties of the log from which the wood product is produced.

### BACKGROUND

Warp (also referred to as distortion) stability and dimensional stability are increasingly important characteristics in wood products. Some products, such as premium-grade joists and studs, require superior dimensional stability and warp stability performance to be accepted by the construction industry. Additionally, warp-prone lumber is only appropriate for use in certain applications.

Wood products can be graded or classified into qualitative groups by the amount of warp potential, or dimensional stability of the product. Grading methods are useful in determining the end use of a wood product, and add the most value when utilized early in the production process. Methods which can be applied to logs to predict properties of the final wood product enable a manufacturer to allocate the logs in a manner that maximizes return. For example, logs having a high stiffness but showing a tendency to produce warp prone lumber might be allocated to veneer for production of parallel laminated lumber. Logs having a lower stiffness and showing a tendency to produce warp prone lumber might be used for other applications such as plywood or oriented strand board.

Currently when log geometry is used as a predictor for warp potential, large scale geometric features are examined. Examples of features currently examined to predict warp include sweep (the curvature or bend of the log), taper (the gradual diminution of thickness, diameter, or width in the log), maximum deviation from a straight reference line, height at which maximum deviation occurs, ovality of the log cross-sectional shape, and eccentricity of the log. Other methods use combinations of log geometry and stress wave measurement to improve the warp propensity estimate. Methods using these techniques are described, for example, in U.S. Pat. No. 6,996,497 and U.S. Pat. No. 6,598,477, which are hereby incorporated by reference. Although these methods have proven useful, wood technologists continue to look for new properties in logs that indicate warp potential and new ways to analyze properties to predict warp.

Thus there is a need to develop an improved method for predicting the warp potential of a wood product based on the geometry and, in some embodiments, other properties of the log from which it is produced. An improved method for predicting warp this early in the production process could lead to significant increases in return by enabling manufacturers to allocate logs that have a threshold possibility of producing warp prone products to selected applications where warp propensity is not as crucial of a factor as it is in other applications.

### SUMMARY

The following summary is provided for the benefit of the reader only and is not intended to limit in any way the invention as set forth by the claims. The present disclosure is directed generally towards predicting the warp potential of a wood product based on the geometry of the log from which the wood product is produced.

In one embodiment, methods for predicting warp of the wood product produced from a log start with performing a three dimensional scan of the log to obtain geometric data. This scan may be performed at a bucking system at a merchandiser, at a primary breakdown system, or at any other stage of the wood product manufacturing process. The geometric data is then used to form a log profile. The geometric data in the log profile is then partitioned into geometric components. Selected geometric components are removed to create residual grid profiles. This step can optionally be repeated and various types of geometric components can be analyzed and removed. Geometric statistics are then derived from either the log profile or one of the residual grid profiles. Selected geometric statistics are used to create a model for predicting warp of the wood product. The geometric statistics can include both orientation dependent and orientation independent statistics.

Further aspects of the disclosure are directed towards wood products produced using the method described above. In some embodiments, the wood product is lumber and the warp potential relates to bow, crook, cup, and twist. In other embodiments the wood product may be a veneer product or any other type of wood product known to those of ordinary skill in the art. In some embodiments, the model for predicting warp may also utilize additional measurements such as stress wave velocity measurements, spiral grain angle measurements, ultrasound velocity measurements, multimode frequency and damping measurements, branch location and size, ring patterns, evidence of compression wood, and density measurements.

### BRIEF DESCRIPTION OF THE DRAWINGS

The present disclosure is better understood by reading the following description of non-limitative embodiments with reference to the attached drawings wherein like parts of each of the figures are identified by the same reference characters, and are briefly described as follows:

FIGS. 1-4 show examples of various types of warp that can occur in a wood product;

FIG. 5 shows a three-dimensional scan of a log obtained using methods according to the disclosure;

FIGS. 6-11 show examples of residual grid profiles and methods for obtaining residual grid profiles according to embodiments of the disclosure;

FIG. 12 shows a redrawn version of FIG. 5 as a wire mesh; and

FIGS. 13-20 show graphs depicting the fit of the predicted warp (bow, crook, or twist) based on the log data versus the observed warp based on the lumber data.

### DETAILED DESCRIPTION

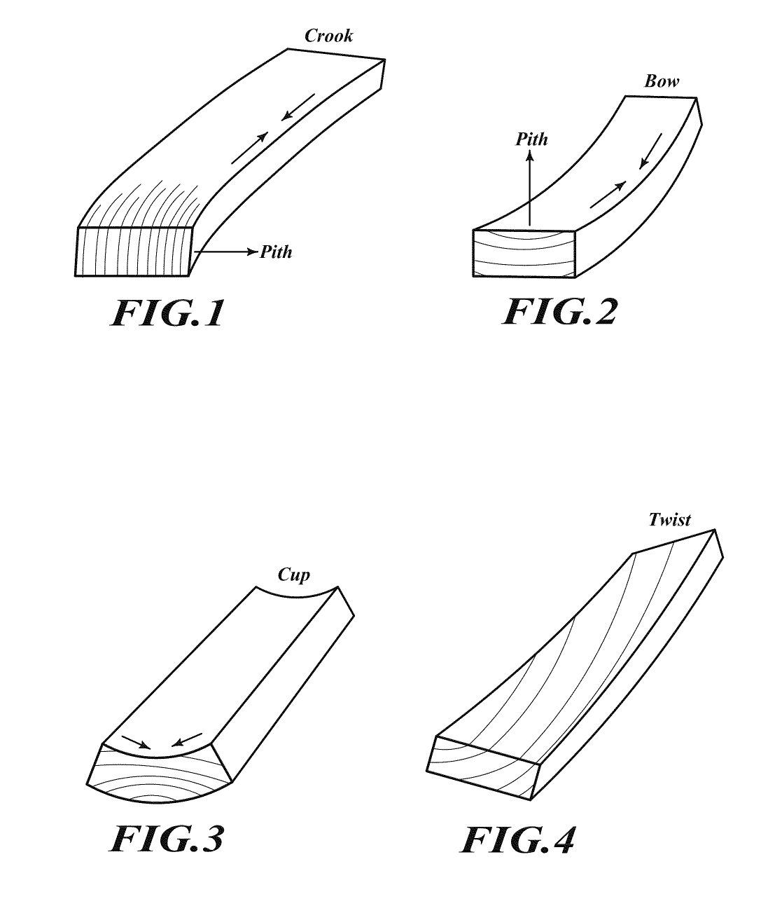

The present disclosure describes methods for predicting the warp potential of a wood product based on the geometry and, in some embodiments, other properties of the log from which the wood product is produced. Certain specific details are set forth in the following description and FIGS. 1-20 to provide a thorough understanding of various embodiments of the disclosure. Well-known structures, systems, and methods often associated with such systems have not been shown or described in details to avoid unnecessarily obscuring the description of various embodiments of the disclosure. In addition, those of ordinary skill in the relevant art will understand that additional embodiments of the disclosure may be practiced without several of the details described below.

### Overview

In this disclosure, the term “wood” is used to refer to any cellulose-based material produced from trees, shrubs, bushes, grasses or the like. The disclosure is not intended to be limited to a particular species or type of wood. The term “log” is used to refer to the stem of standing trees, felled and delimbed trees, and felled trees cut into appropriate lengths for processing in a wood product manufacturing facility. The term “wood product” is used to refer to a product manufactured from logs such as lumber (e.g., boards, dimension lumber, headers and beams, timbers, mouldings and other appearance products; laminated, finger jointed, or semi-finished lumber (e.g., flitches and cants); veneer products; or wood strand products (e.g., oriented strand board, oriented strand lumber, laminated strand lumber, parallel strand lumber, and other similar composites).

Warp typically occurs in four orientations, which can be referred to as crook, bow, cup, and twist. Referring to FIG. 1, crook (also called crown) refers to in-plane, edgewise curvature of wood relative to a longitudinal axis. Referring to FIG. 2, bow refers to in-plane facewise curvature relative to a longitudinal axis. Crook and bow are closely related and differ primarily according to the planar surface used to define the warp. Cup, on the other hand, refers to in-plane, facewise curvature of wood relative to a lateral axis as shown in FIG. 3. Twist, another type of warp, refers to a rotational instability about an axis of wood (usually the longitudinal axis) as shown in FIG. 4. Twist is associated with varying grain angle pattern as described in U.S. Pat. No. 6,293,152, which is hereby incorporated by reference. Other forms of warp are influenced by a myriad of factors as described in U.S. Pat. Nos. 6,305,224, 6,308,571 and 7,017,413, which are hereby incorporated by reference.

During the wood product manufacturing process, stems of standing trees and felled and de-limbed trees are processed through a bucking system and/or a merchandising system. The objective of bucking and merchandising is to maximize the trees value by cutting it into logs or segments of varying length and then allocating each log or segment to a downstream process (e.g., lumber, veneer, strand, etc). A bucking system generally refers to a process in which long lengths of logs are cut into shorter segments. A merchandising system refers to a process in which long length logs are cut into shorter segments and each segment has more than one potential downstream process destination. The general sequence of processing steps for a typical lumber manufacturing process includes debarking, bucking to shorter segments, primary breakdown, secondary breakdown, drying, grading, sorting, and finishing.

Logs are typically scanned for size, geometric configuration, and other properties before they approach the bucking system or the primary breakdown system. A typical scanner will make multiple determinations of the log circumference at short intervals along the log's length. These measurements will denote diameter, length, and taper as well as longitudinal sweep and any cross section eccentricity. Typical scanners are generally based on a battery of laser distance measuring cameras that perform the measurements without log rotation. Information from the scanners may be entered into a computer programmed to automatically determine how to buck the log into shorter segments. Information from the scanners may also be entered into a computer programmed to automatically determine the best orientation of the log as it enters the primary breakdown system. The log will then be automatically rotated through the desired angle relative to its position when scanned. The computer will also set the primary breakdown saws and/or chipping heads for the initial cuts to get the maximum lumber value from the log.

### Obtaining Geometric Data

According to some embodiments of the disclosure, a log may be scanned before it enters the merchandising system (e.g., in a sort yard), before it enters the bucking system ahead of a wood product manufacturing facility, or before it enters the first conversion process in the wood product manufacturing facility (e.g., primary breakdown system or lathe). Scanners according to embodiments of the disclosure are configured to perform a three-dimensional scan of the log geometry to obtain geometric data. Additionally the scanners or other scanning equipment may be configured to obtain other types of data such as ultra sound measurements, spiral grain angle measurements, stress wave velocity measurements, multimode resonance measurements, branch location and size measurements (from e.g. color or laser imaging), measurements of ring patterns on the log ends, measurements indicating evidence or severity of compression wood on the log ends (from e.g., hyperspectral imaging), moisture content measurements, weight measurements, and density measurements.

Stress wave velocity of logs can be very useful in prediction of structural and other performance properties of lumber cut from a log. However, it is not generally a convenient measurement to make. It is particularly difficult in many operations where space is limited. It becomes particularly inconvenient where probes must be inserted into or even placed in contact with opposite ends of a log. A simpler measurement that provides similar information without necessitating major mill revisions or procedural changes, would enable much wider application for prediction of lumber properties.

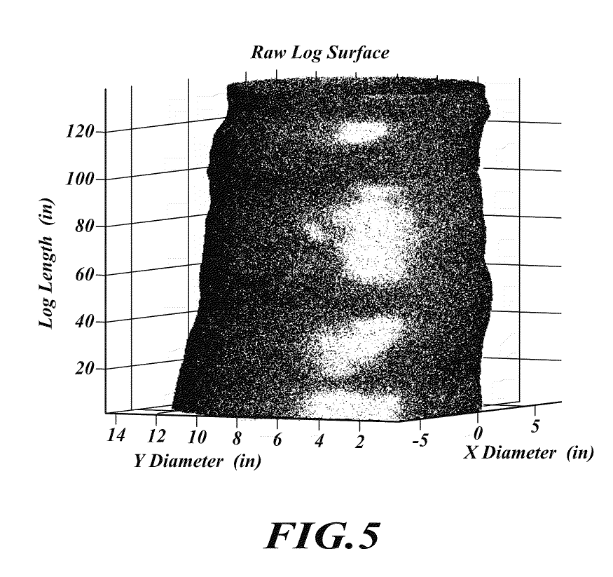

In some embodiments of the disclosure, the geometric data is obtained by measuring the log surface at a fixed number of equally spaced locations along the length of the log and at a fixed number of equally spaced points around the circumference of the log at each of the locations. For example, a log may be scanned by obtaining measurements from 36 equally spaced locations along its length and at 128 equally spaced points around the circumference of the log at each of the 36 locations. Referring to FIG. 5, a three-dimensional scan obtained using methods according to the disclosure is shown. For illustration, this example refers to geometric data originating from 36 locations and 128 points; however, other configurations may be envisioned.

### Log Profile

As shown in FIG. 5, measuring the log in the manner described above creates a log profile composed of approximately 36 discs or rings with 128 points around its circumference. The discs are stacked one above the other in their natural order in the log. If the log is perfectly straight, round and without taper, then log will be shaped like a right circular cylinder, and the points will form a rectangular grid on its surface. Connecting the points will produce 128 vertical lines and 36 horizontal lines all equal in length.

Since real logs are bent and tapered, the grid shown in FIG. 5 is bent and tapered as well. This means that the grid lines are of unequal length and they are no longer perpendicular to each other. The distortions in the grid are thought to arise from non-uniform growth within the log. The three-dimensional coordinates along with the distances and angles between these points are the raw data available for computing geometric statistics discussed in subsequent portions of the disclosure.

### Residual Grid Profiles

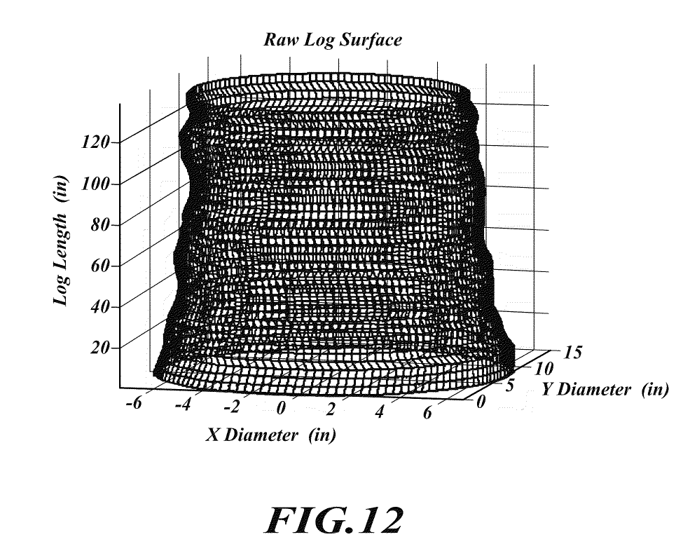

The geometric data in FIG. 5 can be visualized as a log-shaped wire mesh (see, e.g., FIG. 12) having 36 points along its length and 128 points around its circumference. Relative distances between any of the 36×128 surface positions defining the outer surface of the log can be calculated for each of the surface grids created from geometric data or from any of one or more residual grids. A residual grid profile may be created, for example, by removing geometric components from the log profile. Geometric components which can be removed include but are not limited to the shape of a reference cylinder, the numerical pith of the log or the taper function.

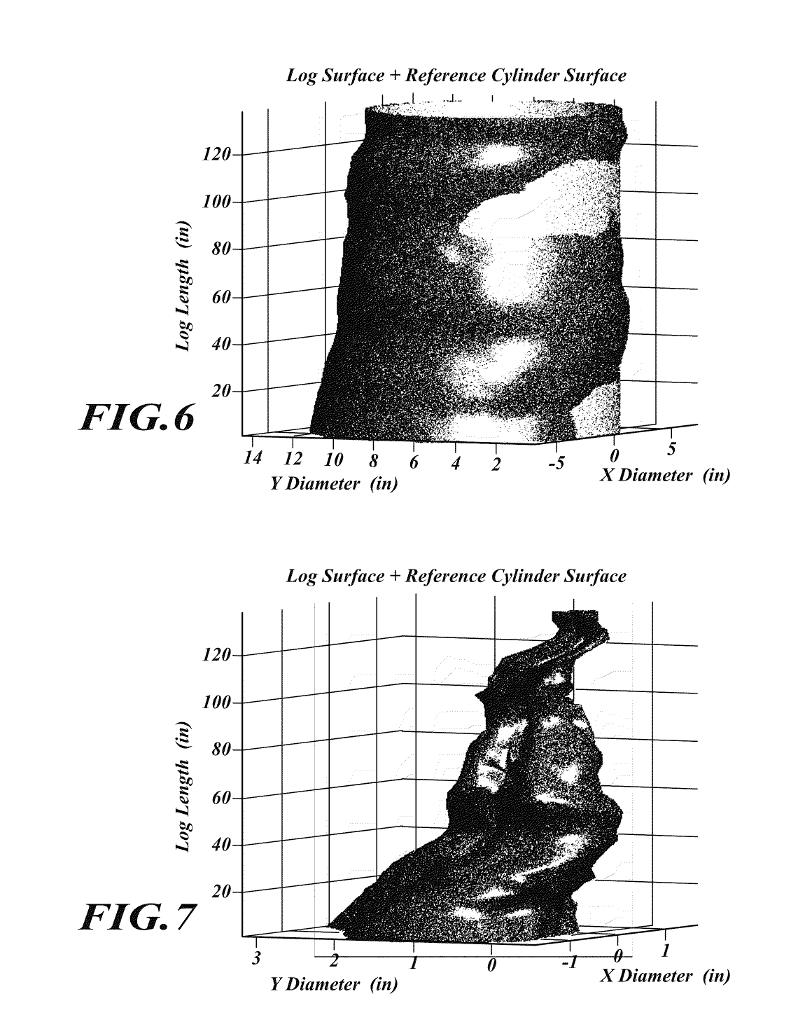

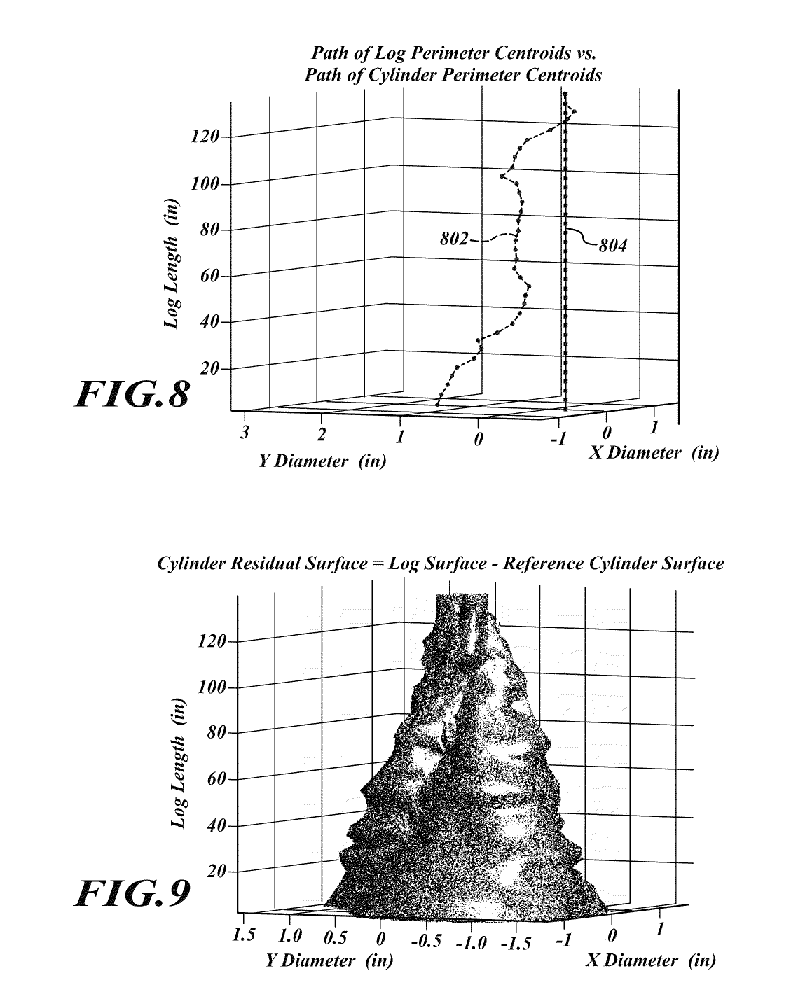

FIGS. 6-11 show examples of residual grid profiles and methods for obtaining residual grid profiles according to embodiments of the disclosure. FIG. 6 shows the log profile from FIG. 5 with a reference cylinder superimposed on the geometric data. FIG. 7 shows an example of a residual grid profile obtained by removing the reference cylinder shown in FIG. 6 from the log profile shown in FIG. 5. FIG. 8 shows the numerical pith 802 of the log which is calculated by following the mathematical center of each the residual grid profile from FIG. 7. For reference, the numerical pith of the reference cylinder 804 is also shown. FIG. 9 shows an example of a residual grid profile obtained by further removing the numerical pith from the residual grid profile shown in FIG. 7. FIG. 10 shows the estimated taper function for the log. The taper function in FIG. 10 may be determined, for example, by estimating the median radius for each set of 128 points along the length of the log. FIG. 10 is an example of an isotropic taper function because it assumes the taper is constant in all directions from the log center. An anisotropic taper function may also be used.

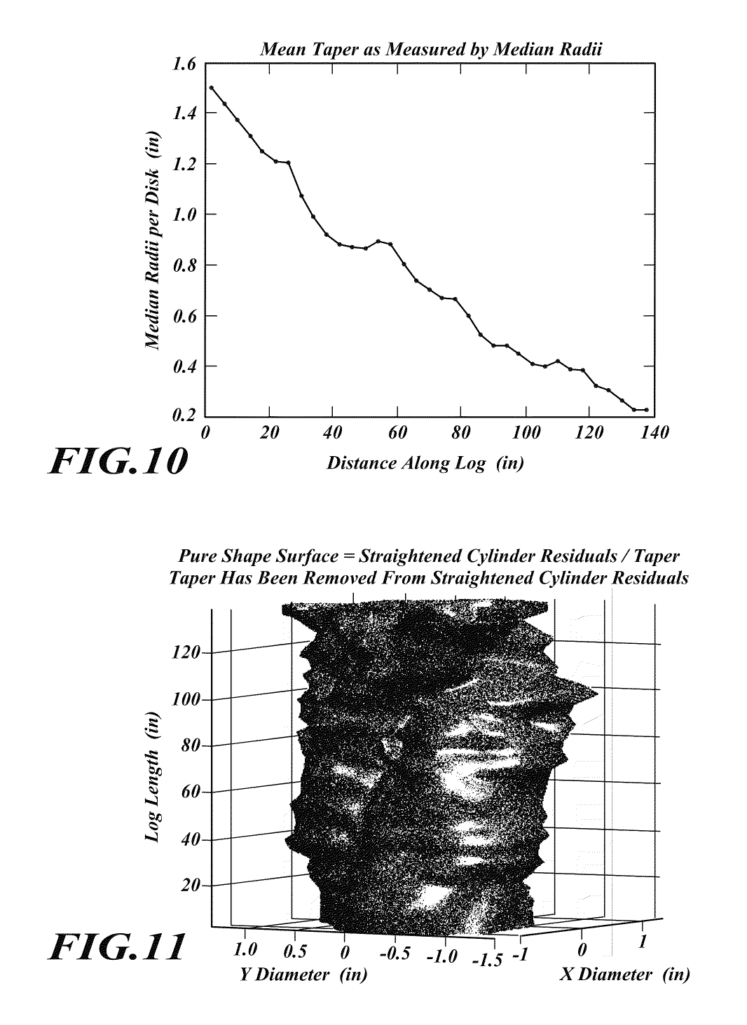

FIG. 11 shows an example of a residual grid profile obtained by further removing the taper function from the residual grid profile shown in FIG. 9. Taper may be removed, for example, by dividing the radius to each point on the circumference by its corresponding taper function value. It should be noted that the surface shown in FIG. 11 can be partitioned further according to some embodiments of the disclosure. For example, it can be partitioned into large and small features, low frequency and high frequency components, or other similar partitions. Those of ordinary skill in the art will appreciate that the log geometry can be partitioned into many different geometric components without departing from the spirit of the disclosure.

As shown in FIGS. 6-11, the 128 distances along the log shown in FIG. 5 will change as each geometric component is removed from the log profile. For example, removing all aspects of sweep will shorten some the distances while lengthening others. Subsequently removing taper will change the distances again. Thus, summarizing the changes in the distances along the log with geometric statistics as different aspects of its geometry are removed will summarize the effects of the geometric aspects of the log. Geometric statistics may be calculated from either the log profile or from any residual grid profile.

### Geometric Statistics

In order to find relationships between log geometry and the quality characteristics of wood products made from the log, one can calculate geometric statistics that summarize the log geometry in a way that enables the geometric statistics to be used in models to indicate the quality of the wood products. Geometric statistics are functions of the log geometry data, which can be estimated from the log profile (FIG. 5 and FIG. 12) or from any of the objects shown in FIGS. 6-11 above. There are an infinite number of functions which can be used. The functions can be linear or nonlinear. They can use all of the data or just portions of the data. They can be independent of log orientation or position along the log, or they can be dependent on the orientation or position along the log. They can be very complex or very simple. They can summarize features at the whole log scale or they can summarize features at smaller scales. They can be comparisons between other statistics calculated at different locations or different scales.

Accordingly, an enormous number of statistics can be calculated. Therefore it is useful to have some guiding principle to govern the selection of statistics summarizing the log geometry as it relates to wood product quality. Lumber warps as it dries because differential stresses are created by the wood shrinking differently at different location throughout the wood. Presumably, if a tree grew perfectly uniformly throughout its whole stem, then lumber could be cut from it such that it wouldn't warp. Thus, the guiding principle is the hypothesis that nonuniform growth within the tree stem is manifested to some degree in the external log geometry at different scales. Though external forces, environment and events cause nonuniform tree growth, the nonuniform growth produces the final shape of the tree overall as well as at the smaller scales. Furthermore if these internal nonuniformities can be localized to a particular region of the tree stem or a log bucked from the stem. An example of this is a tree growing scar tissue over a gash on its trunk. The result is a bulge in the tree trunk over the gash. With the passage of time, the bulge becomes less obvious as the tree grows out the rest of the trunk around the old wound. Though less obvious, the bulge is still present and can be detected by geometric statistics that compare local parts of the log geometry to each other.

Those of ordinary skill in the art often think about log geometry in terms of the overall sweep, the location where sweep occurs, how pronounced sweep is, taper, the ovality of the log cross section, and other whole-log geometric aspects of the log. Conventional techniques commonly utilize average geometric characteristics. In embodiments according to the disclosure, many geometric statistics that summarize distributional properties (e.g., standard deviation, skewness and kurtosis) among local statistics calculated at different places on the log or differences between statistics calculated at different places on the log may be utilized.

For example, one can calculate distances between the 36 points along the log at each of the 128 circumferential positions. This can be calculated for any kind of surface grid created from geometric data or from any of the residual grid profiles shown in FIGS. 6-11. The sum of the pair wise distances will yield 128 distances along the log. For a very uniformly shaped tree, these 128 will be the same and thus their standard deviation will be zero. The distances calculated for bent or rough log will not all be the same and so the standard deviation will be greater than zero. Differences between distances on opposite sides of the log can be treated the same way. A zero value for the standard deviation of the 64 differences indicates that the log has very parallel sides.

To visualize how geometric statistics are calculated according to embodiments of the disclosure, it is useful to think of the scan data as a wire mesh. FIG. 5 has been redrawn as a wire mesh in FIG. 12. The x-, y-, z-coordinates for each intersection of black lines on the surface of the mesh are the raw data available for analysis. Recall that in this example there are 128 measurements around the circumference of the log and there are 36 of these sets of measurements along the log. Thus, a log is described by the 3-D coordinates of 4,480 points in 3-D space.

Each line connecting two points on the surface of the mesh in FIG. 12 can be thought of as a vector. The length and direction of these vectors can be calculated. Also, the angles between consecutive vectors can be calculated. The distance along each vertical line running up the mesh can be calculated by summing the lengths of vectors comprising that line. This yields 128 lengths up the mesh. If the tree grew perfectly uniformly then the surface represented in FIG. 12 would be a smooth cylinder. The distances up the mesh of smooth cylinder would all be the same so the standard deviation of such distances would be zero. In the example shown, the 128 distances up the mesh in FIG. 12 are not the same, so their standard deviation is not zero. The mean, standard deviation, skewness and kurtosis of the 128 distances may also be calculated according to some embodiments of the disclosure. This can be done for each profile in FIGS. 5, 7, 9, and 11. These distances measure the amount of stretch or distortion in the log caused by non-uniform growth within the stem. Instead of distance, angular deflections may also be calculated along the log. Other similar measurements envisioned by those of ordinary skill in the art are also within the scope of this disclosure.

The difference between the geometric statistics from the objects in FIGS. 5 and 7, for example, capture the effect of removing the compound sweep in the log. Similar differences with the other residual grid profiles may also be calculated according to some embodiments of the disclosure. Also, the difference between distances on opposite sides of the log or the differences between distances separated by a few degrees on the log circumference may, if nonzero, be related to differential growth within the tree stem. As explained, for example, in U.S. Pat. No. 6,598,477, this may be related back to warp.

The above descriptions of geometric statistics based on distances can be repeated for angles between consecutive vectors. This will yield a different set of statistics measuring the waviness of the log surface. The sum of the absolute value of the angles will give total angular displacement or the total amount of in-and-out directional changes in the surface of the log. The standard deviation of the angular deflections will have a similar meaning.

### Creating a Model

Many other kinds of geometric statistics may be created according to embodiments of the disclosure. For example, the mesh in FIG. 12 can be viewed as a field of vectors running along the log or around it. The same is true of the shape of the path traced out by the log center shown in FIG. 8. The divergence, curl, Laplacian, and tangential component of the vectors can be calculated. Coefficients from models of the taper function in FIG. 11 may also be used as geometric statistics. Examples of geometric statistics used to model bow, crook, and twist and their inclusion frequency in models according to embodiments of the disclosure are shown in Tables 1-6 below. The inclusion frequency represents the fraction of times the geometry statistic was selected and remained a statistically significant term in the regression models.

TABLE 1
Bow Modeled Without Stress Wave Velocity

| | Inclusion |
|---|---|
| Geometry Statistic | Frequency |
| Real part of the 2^{nd} harmonic from the FFT of the divergence of the numerical pith | 0.875 |
| 2nd eigenvalue of pith covariance matrix | 0.835 |
| Skewness of the normalized box surface area at angular position 28 or 79 degrees from | 0.810 |
| horizontal | |
| Imaginary part of the 1^{st} harmonic of the FFT of the cosine of the angles between centroids | 0.760 |
| along the numerical pith | |
| Kurtosis of the box surface areas at position 45 or 127 degrees from horizontal. | 0.700 |
| Standard deviation of the side-to-side difference between angular deflections in the log surface | 0.700 |
| at angular position 58 or 163 degrees from horizontal. The difference is between angles 163 | |
| degrees and 343 degrees from horizontal. The angles span 8 inches of log length. Prior to | |
| calculating the angles the log surface data was smoothed with a 3 × 9 moving median filter. | |
| Kurtosis of the side-to-side difference between angular deflections in the log surface at angular | 0.640 |
| position 4 or 11 degrees from horizontal. The difference is between angles 11 degrees and | |
| 191 degrees from horizontal. The angles span 8 inches of log length. Prior to calculating the | |
| angles the log surface data was smoothed with a 3 × 9 moving median filter. | |
| Kurtosis of box surface areas at angular position 44 or 124 degrees from horizontal. | 0.600 |
| Real part of the 7^{th} harmonic from the FFT of the divergence of the numerical pith | 0.535 |
| Skewness of the side-to-side difference between angular deflections in the log surface at | 0.505 |
| angular position 35 or 98 degrees from horizontal. The difference is between angles 98 | |
| degrees and 278 degrees from horizontal. The angles span 8 inches of log length. Prior to | |
| calculating the angles the log surface data was smoothed with a 3 × 9 moving median filter. | |

TABLE 2
Bow Modeled With Stress Wave Velocity

| | Inclusion |
|---|---|
| Geometry Statistic | Frequency |
| Kurtosis of the normalized box volume at angular position 27 or 76 degrees | 0.800 |
| from horizontal. The box volumes were calculated after the log surface data | |
| was smoothed with a 3 × 9 moving median filter. | |
| Skewness of the normalized box surface area at angular position 28 or 79 | 0.74 |
| degrees from horizontal | |
| 2nd eigenvalue of pith covariance matrix | 0.710 |
| Kurtosis of box surface areas at angular position 45 or 126 degrees from | 0.620 |
| horizontal. | |
| Real part of the 2^{nd} harmonic from the FFT of the divergence of the numerical | 0.605 |
| pith | |
| Kurtosis of box surface areas at angular position 44 or 124 degrees from | 0.585 |
| horizontal. | |
| Standard deviation of the side-to-side difference between angular deflections in | 0.585 |
| the log surface at angular position 58 or 163 degrees from horizontal. The | |
| difference is between angles 163 degrees and 343 degrees from horizontal. | |
| The angles span 8 inches of log length. Prior to calculating the angles the log | |
| surface data was smoothed with a 3 × 9 moving median filter. | |
| Kurtosis of the 128 standard deviations of the box surface areas calculated | 0.545 |
| along the log. The log surface data was smoothed with a 3 × 9 moving median | |
| filter. | |
| Skewness of the box surface area at angular position 23 or 65 degrees from | 0.510 |
| horizontal. The log surface data was smoothed with a 3 × 9 moving median filter. | |

TABLE 3
Crook Modeled Without Stress Wave Velocity

| | Inclusion |
|---|---|
| Geometry Statistic | Frequency |
| Imaginary part of the 7^{th} harmonic from the FFT of the divergence of the numerical pith | 0.990 |
| Skewness of the side-to-side differences of box volumes at angular position 4 or 10 | 0.980 |
| degrees from horizontal. The log surface data was smoothed with a 3 × 9 moving median | |
| filter. This is on a 12 inch scale. | |
| Kurtosis of normalized box volumes at angular position 46 or 129 degrees from | 0.860 |
| horizontal. The log surface data was smoothed with a 3 × 9 moving median filter. This is | |
| on a 12 inch scale. | |
| Standard Deviation of the side-to-side difference in normalized box surface areas at | 0.840 |
| angular position 38 or 107 degrees from horizontal. The difference is between | |
| normalized box surface areas at 107 and 287 degrees from horizontal. This is on a 12 | |
| inch scale. | |
| Mean of the side-to-side difference between angular deflections in the log surface at | 0.750 |
| angular position 28 or 79 degrees from horizontal. The difference is between angles 79 | |
| degrees and 159 degrees from horizontal. The angles span 8 inches of log length. | |
| Standard deviation of the normalized box surface areas at angular position 6 or 17 | 0.740 |
| degrees from horizontal. The log surface data was smoothed with a 3 × 9 moving median | |
| filter. This scale is 12 inches. | |
| Kurtosis of normalized box surface areas at angular position 34 or 96 degrees from | 0.615 |
| horizontal. Scale is 12 inches. The log surface data were smoothed with a 3 × 9 moving | |
| median filter. | |
| 2nd eigenvalue of pith covariance matrix | 0.525 |

TABLE 4
Crook Modeled With Stress Wave Velocity

| | Inclusion |
|---|---|
| Geometry Statistic | Frequency |
| Kurtosis of the side-to-side difference between angular deflections in the log surface at | 0.970 |
| angular position 58 or 163 degrees from horizontal. The difference is between angles | |
| 163 degrees and 343 degrees from horizontal. The angles span 8 inches of log length. | |
| Prior to calculating the angles the log surface data was smoothed with a 3 × 9 moving | |
| median filter. | |
| Standard Deviation of the side-to-side difference in normalized box surface areas at | 0.945 |
| angular position 38 or 107 degrees from horizontal. The difference is between | |
| normalized box surface areas at 107 and 287 degrees from horizontal. This is on a 12 | |
| inch scale. | |
| Skewness of the side-to-side differences of box volumes at angular position 4 or 10 | 0.935 |
| degrees from horizontal. The log surface data was smoothed with a 3 × 9 moving median | |
| filter. This is on a 12 inch scale. | |
| Kurtosis of the normalized box surface areas at angular position 33 or 93 degrees from | 0.925 |
| horizontal. | |
| Imaginary part of the 7^{th} harmonic from the FFT of the divergence of the numerical pith | 0.800 |
| 2nd eigenvalue of pith covariance matrix | 0.700 |
| Skewness of the 128 total absolute angular displacement statistics around a log. | 0.665 |
| Real part of the 1^{st} harmonic of the FFT of the curl of the numerical pith. | 0.660 |
| Skewness of the 64 mean side-to-side differences between angular deflections in the log | 0.635 |
| surface. The angles span 8 inches of log length. | |

TABLE 5
Twist Modeled Without Spiral Grain Angle

| | Inclusion |
|---|---|
| Geometry Statistic | Frequency |
| Angular orientation of the 3rd largest peak in the 2-D Power spectrum of the shape | 0.960 |
| residuals. | |
| Standard deviation of the side-to-side difference between angular deflections in the log | 0.780 |
| surface at angular position 3 or 8 degrees from horizontal. The difference is between | |
| angles 8 degrees and 188 degrees from horizontal. The angles span 8 inches of log | |
| length. | |
| Minimum difference between horizontal deflection angles 90 degrees or one quarter of a | 0.730 |
| log circumference apart. | |
| Mean ridge angle | 0.690 |
| Standard deviation of the sum of several side-to-side differences of shape statistics at | 0.630 |
| angular positions 58 and 59 or 163 to 165 degrees. The difference is between statistics | |
| 163 to 165 degrees and 343 to 345 degrees from horizontal. The scale spans 8 inches | |
| of log length. | |

TABLE 6
Twist Modeled With Spiral Grain Angle

| | Inclusion |
|---|---|
| Geometry Statistic | Frequency |
| Lags 62 and 63 of the difference between the variograms of the middle half of the | 0.910 |
| distances along the log calculated from the cylinder residuals and the final shape | |
| residuals. | |
| Minimum difference between horizontal deflection angles 180 degrees or one half of a | 0.870 |
| log circumference apart. | |
| Angular orientation of the 3rd largest peak in the 2-D Power spectrum of the shape | 0.815 |
| residuals. | |
| Real part of the 2^{nd} harmonic of the FFT of the curl of the numerical pith. | 0.720 |
| Standard deviation of the standard deviations of the 128 sets of divergences calculated | 0.635 |
| from the 128 sets of coordinates of the cylinder residuals. | |
| Standard deviation of the side-to-side difference between angular deflections in the log | 0.610 |
| surface at angular position 3 or 8 degrees from horizontal. The difference is between | |
| angles 8 degrees and 188 degrees from horizontal. The angles span 8 inches of log | |
| length. | |
| Standard deviation of the sum of several side-to-side differences of shape statistics at | 0.605 |
| angular positions 58 and 59 or 163 to 165 degrees. The difference is between statistics | |
| 163 to 165 degrees and 343 to 345 degrees from horizontal. The scale spans 8 inches | |
| of log length. | |
| The Kurtosis of the standard deviations of the normalized box volumes. The log surface | 0.530 |
| data was smoothed with a 3 × 9 moving median filter. | |

The angular directions around each log are not tied to the directions of the compass, because they are a function of how the log was mechanically oriented when it was scanned. Since the directions are not anchored to the directions of the compass, they are arbitrary. However, since the logs are generally oriented in a “horns up” or “horns down” orientation to facilitate breakdown decisions, the angular directions around a log will tend to align to some degree for some of the logs. The angular directions on straight logs will reflect a completely random orientation. Therefore, two types of geometric statistics can be calculated: “orientation dependent statistics” and “orientation independent statistics.”

### Orientation Independent Statistics

Orientation independent statistics are geometric statistics calculated from geometric data wherein the specific location (e.g., circumferential or longitudinal) of the measurements taken to obtain the geometric data and the orientation of the log while it is being measured is not relevant for warp prediction. Examples of orientation independent statistics include but are not limited to the Fourier transform, the autocorrelation function, and the variogram.

For example the first geometry statistic listed in Table 6 is lag 63 of the difference between the variograms of the middle half of the distances along the log calculated from the cylinder residuals and the final shape residuals. The 128 distances described above may be calculated using only the middle half of the log geometric scan data in order to ignore the geometric variability in the ends of the logs. The distances may be calculated from the cylinder residual surface (see FIG. 6) and the residual shape surface (see FIG. 11). A variogram may be calculated from each set of 128 distances. The variogram is the mean squared difference between distances and their 1st, 2nd, 3rd, etc, neighbors to the right (called lags) around the circumference. Since the variogram is calculated from points located on a closed loop there are no edge effects. The lag 1 value of the variogram is the mean squared difference between every distance and their neighbor to their immediate right. Since the variograms use all of the distances around the log they are independent of log orientation.

As a second example, the first geometry statistic listed in Table 1 is the real part of the second harmonic from the fast Fourier transform of the divergence of the numerical pith. Divergence may be calculated for each point on the numerical pith having a point on either side. The divergence is the sum of the first derivatives of the x-, y- and z-coordinates. The Fourier transform of these divergence values along the log center may be calculated and the real part of the second harmonic or the coefficient of the send cosine wave in the transform may be used as geometric statistics. The value of this statistic will not change if the log is oriented differently from the original data. This statistic measures how much the tree moved back and forth as it grew, and is related to bow.

Differences between the variogram of the residual grid profiles after the reference cylinder has been removed, and the variogram of the residual grid profiles after the numerical pith has been removed may reflect a twisted and bent nature of the log. A similar result may be achieved by calculating the differences between variograms of the residual grid profiles before and after the taper function as been removed. Furthermore, a similar result may also be achieved by calculating differences between autocorrelation functions and Fourier transforms. In some embodiments, patterns in the Fourier transform or in the variogram are of interest. In such cases, kernel matrices, principal components or other types of summary methods may also be calculated.

In some embodiments, the x-, y- and z-coordinates of surfaces in FIGS. 5, 7, 9, and 11 and may be treated as a set of trivariate data and the variance-covariance matrix of the coordinate-data are calculated. The eigenvalues of the variance-covariance matrix along with functions of them become whole log summaries of the log geometry and thus are direction independent.

Another set of geometric statistics that can be calculated are based on the centroids of the 36 discs or sets of 128 points. This is a set of 36 points in three dimensional space. Usually the path traced out by this set of points looks like a bent twisted piece of wire. One of the ways of summarizing this bent twisted shape is to treat the coordinates as trivariate data and calculate their variance-covariance matrix. The eigenvalues of this matrix summarize the spread of the data. The first eigenvalue describes the variation due to the length of the log. The second and third eigenvalues describe the variation due to sweep, twist and misshaped sections of the log.

Other statistics that can be estimated from the 36 centroids come from descriptions of vector fields. These include divergence, curl, Laplacian, and the tangential component. The divergence describes how the direction of the log changes, the curl describes how the log curves, the Laplacian describes how changes in the direction the log grew changed and the tangential component is related to the twisted bent nature of the log.

These vector field statistics can be calculated for each of the 128 sets of points running along the log surface as well. Fourier transforms and variograms of these statistics as well as simple means, standard deviations and other summary statistics can also be calculated to obtain orientation independent statistics. Differences between statistics on opposite sides of the log or with statistics at some other angle can also be used to describe log geometry and non-uniformity in log growth, which is a condition contributing to warp propensity.

### Orientation Dependent Statistics

Orientation dependent statistics are geometric statistics calculated from geometric data wherein the specific location (e.g., circumferential or longitudinal) of the measurements taken to obtain the geometric data and the orientation of the log while it is being measured is relevant for warp prediction. Examples of orientation dependent statistics include but are not limited to the distances along the sides of the log at the circumferential positions, means, standard deviations, coefficients of skewness and kurtosis of the point-to-point distances along the log at each of the 128 angles, giving statistics at 128 angles around the log related to orientation. The vector field statistics estimated at the 128 angles around the log are also in this category. Other direction dependent statistics arise from attempting to capture the degree to which different parts of a log stretch or wiggle relative to one another. Calculating statistics using the data from just one end of the log will create statistics that depend on which end of the log is used. Switching to the other end can change the value of the statistic. Alternatively calculating the same statistic from both ends of the log and differencing them will create a statistic that is independent of the log orientation.

The number of possible orientation dependent statistics one can calculate is staggering. Some examples of statistics are illustrated below. The statistics listed are not intended to be an exhaustive listing of all possible embodiments. Rather they are intended to illustrate how to calculate such statistics in exemplary embodiments of the disclosure.

If one takes the 36 points along one of the vertical lines of the log profile or the residual grid profile and creates four-point subsets of sequential points that overlap by three points one will get 32 such subsets. The first subset contains the first through fourth points; the second subset contains the second through fifth points; the third subset contains the third through sixth subset; and so on to the thirty-second subset.

For each subset of four points the smallest bounding box or hexahedron that contains the points is determined. The three dimensions of the k-th box are rx=max(x)−min(x), ry=max(y)−min(y) and rz=max(z)−min(z), where x, y and z represent the x-, y- and z-Cartesian coordinates of the four points of the k-th subset. The volume of the k-th hexahedron is v(k)=rx*ry*rz; the surface area is sf(k)=2*rx*ry+2*rx*rz+2*ry*rz. The volume and surface area of the hexahedron that bounds all 36 points may also be calculated. The volumes and surface areas of the 4-point boxes can be divided by the volume and surface area of the 36-point box to normalize them and remove variation due to log size.

The bounding boxes or hexahedrons may be used to measure the wiggliness of a set of points in 3-space. If both volume and surface area are 0, then the points stack a top one another in a straight vertical line. If the points curve or zig-zag in a plane, then the volume will be zero, but the surface area will be greater than 0. More complex distributions of points will yield non-zero values for both volume and surface area. Obviously, multiple configurations of points can yield the same pair of volume and surface area, so they are not unique. Nested subsets of points can be used to create more complex indices of wiggliness or log surface lumpiness. Also, including more points in the subsets or choosing points further apart on the log profile or residual grid profile will examine the wiggliness of larger scale features of the log shape.

Another measure of wiggliness according to embodiments of the disclosure is calculating the angle between the rays connecting three points adjacent to each other. The rays emanate from the center point to the points on either side. Any point not on the end of the log profile or residual grid profile has 8 neighbors which can be viewed as terminal points of 6 vectors emanating from the center point. The angles between the vectors on opposite sides of the center point can be calculated. This yields 4 angles. The sum of the absolute value of these angles gives a measure of how much that side of the log at that position deviates from straight. Differences between such angles across the log from each other measures how parallel the sides of the log are. Geometric statistics may be calculated based on these angles and their differences. The same can be done for the difference in the length of the vectors on opposite sides of the center point.

According to some embodiments of the disclosure, many of the geometric statistics calculated from the log profile or residual grid profile assume that differences between geometric statistics calculated on points at different locations on the log are related to differences inside the log which in turn give rise to warp prone lumber. There are many geometric differences that may be used. The across log difference is the most commonly used difference here. Across the log differences are simple and intuitive as they answer the question “Did the same thing happen on both sides of the tree?” If opposite side of a log are geometrically different, then there is a potential of warp prone lumber to be produced from the log. Other geometric difference examples include, for example, differences between statistics right next to each other in the circumferential direction and statistics 90 degrees apart in the circumferential direction. Sometimes 8-neighbor distances are used and differences between points a quarter of a circumference apart.

In some embodiments, simple statistics are calculated for each geometric statistic calculated from the 36 points at each of the circumferential positions. The statistics may include the mean, standard deviation, skewness coefficient and kurtosis coefficient. Each of these has a geometric meaning. The mean is the average property that was measured or calculated from the data. The standard deviation measures the amount of spread or non-uniformity in the values of the property of interest. The skewness coefficient measures the balance between large and small values of a property. The kurtosis coefficient measures how the distribution of the values concentrate about the mean and extremes.

A similar example can be created for longitudinal position dependence and independence. For example, an amplitude spectrum of the two dimensional Fourier transform of the top one third of a grid as such the residual shape surface shown in FIG. 11 and the same for the bottom one third of a grid can be calculated. From these spectra, the direction angles of the significant peaks can be found along with their associated number of oscillations. The spatial pattern of the significant spectral peaks can also be summarized. The statistics from either end are orientation dependent statistics. Differences between the two sets of statistics are orientation independent statistics. Since all of the grid points around the top one third of the log are used the statistics are circumferentially orientation independent. The minimum direction angle of the significant peaks for the top one third of residual shape grid is a statistic that correlates with the degree to which lumber will twist.

From the foregoing, it will be appreciated that the specific embodiments of the disclosure have been described herein for purposes of illustration, but that various modifications may be made without deviating from the disclosure. Aspects of the disclosure described in the context of particular embodiments may be combined or eliminated in other embodiments. For example, geometric statistics used in models from one embodiment may be used in other embodiments. In addition, other measurements such as ultra sound measurements, spiral grain angle measurements, stress wave velocity measurements, multimode resonance measurements, branch location and size measurements (from e.g. color or laser imaging), measurements of ring patterns on the log ends, measurements indicating evidence or severity of compression wood on the log ends (from e.g., hyperspectral imaging), moisture content measurements, weight measurements, and density measurements may be used in models according to some embodiments.

Partitioning raw log geometry into intuitively natural components according to methods of the disclosure may create very targeted geometry statistics that capture specific attributes of the log geometry. Geometry statistics may be calculated at different scales and at different locations on a log. Statistics from different locations can be compared or combined to produce new statistics that relate external log geometry to lumber warp. Methods according to the disclosure allow a potentially infinite number of geometry statistics to be defined, using any function that can describe or summarize geometric attributes of log useful for indicating or predicting warp. Use of methods according to the disclosure may help manufacturers of wood products increase return by enabling the allocation of logs having a threshold possibility of producing warp prone products to selected applications where warp propensity is not as crucial of a factor as it is in other applications

Further, while advantages associated with certain embodiments of the disclosure may have been described in the context of those embodiments, other embodiments may also exhibit such advantages, and not all embodiments need necessarily exhibit such advantages to fall within the scope of the disclosure. Accordingly, the invention is not limited except as by the appended claims.

The following example will serve to illustrate aspects of the present disclosure. The example is intended only as a means of illustration and should not be construed to limit the scope of the disclosure in any way. Those skilled in the art will recognize many variations that may be made without departing from the spirit of the disclosure.

### Example 1

A study was conducted using a data set compiled from 143 logs from more than 50 Loblolly Pine trees. Each of the logs was bucked to a length of twelve feet. The data gathered for each log(“log data”) included a full three-dimensional surface scan, stress wave velocity, spiral grain angle, ultrasound velocity in eight directions, bending resonance, and compression wood fraction. As the logs were processed into lumber, they were identified and tracked so that the lumber could be traced back to its source. The lumber from the logs was dried and the bow, crook, and twist were measured for each board (“lumber data”).

Thousands of geometric statistics were calculated from the logs. In order to build regression models of lumber warp, a subset of statistics was selected. Ranks of geometric statistics were correlated with ranks of the corresponding lumber warp statistics. Ranks were used in place of the actual values to eliminate spuriously high correlations due to extreme values. The geometric statistic with the highest positive correlation and the log geometry statistic with the lowest negative correlation were selected for each type of lumber warp modeled. The warp statistics were regressed on the geometric statistics and the residual grid profiles were calculated. All of the remaining geometric statistics were also regressed on the two selected geometric statistics and their residual grid profiles were calculated. The correlations between the rankings of the warp statistic residual grid profiles and the rankings of the geometric statistics were calculated and the geometric statistics with the highest positive value and lowest negative value are selected as the next geometric statistics to include in the regression model.

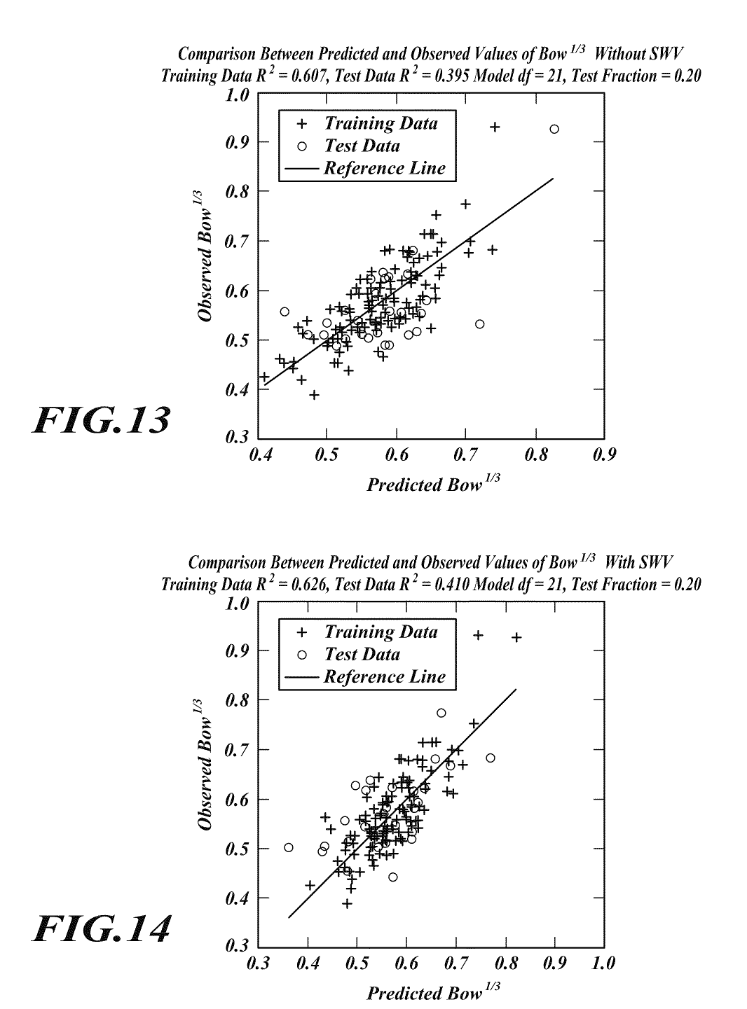

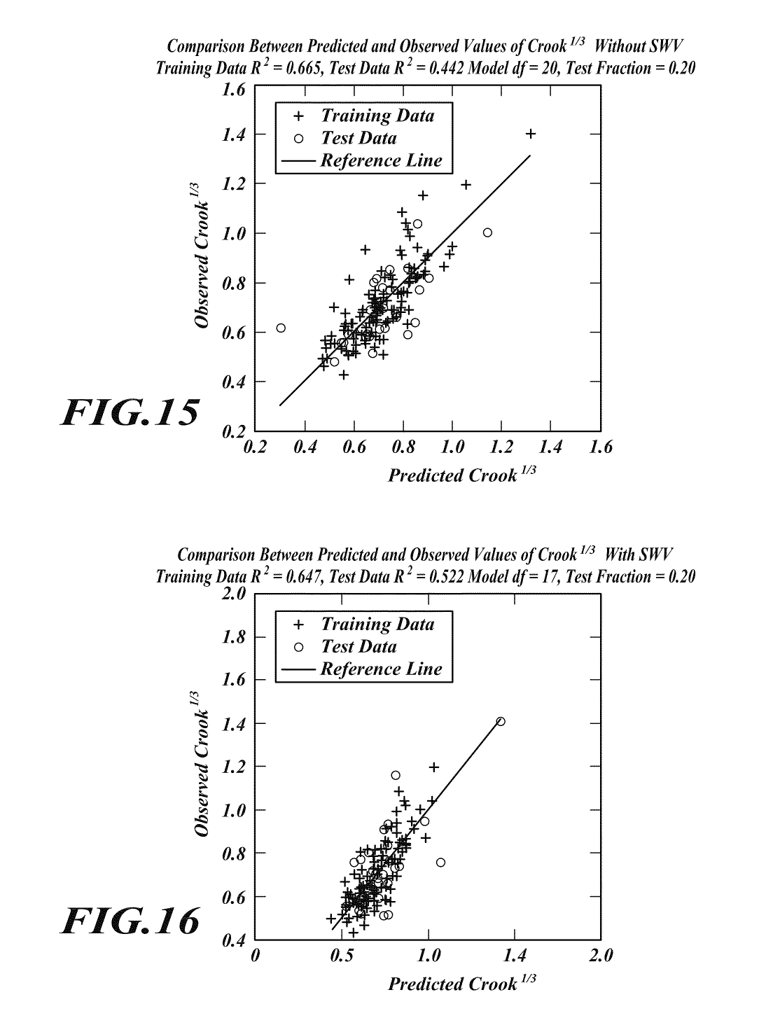

This selection and testing process was iterated for a fixed number of pairs of geometric statistics. The entire process was repeated for a fixed number of iterations using different random subsets of the data to assess the variability in the geometric statistic selection process and model predictive ability. The data were randomly split into subsamples: 80% for model training and 20% for model testing predictions. Tables 7-12 show the regression models with their respective terms and coefficients for the modeling. FIGS. 13-18 show graphs depicting the fit of the predicted warp (bow, crook, or twist) based on the log data versus the observed warp based on the lumber data. The models in Tables 7-12 are termed median models here because the fixed number of iterations was 201 and the model with the median R-squared value was reported. The axes of the observed warp values differ between pairs of plots in FIGS. 15 and 16 and FIGS. 17 and 18 because the random samples of data used in the models differed.

### Example Models for Predicting Bow

A number of different models were used to predict bow of the lumber sawn from the sampled logs. Tables 7 and 8 show two examples of models for predicting bow; however, these are merely illustrative and the disclosure should not be limited to models including only these geometric statistics.

TABLE 7
Median Model for Bow Without Stress Wave Velocity
Median Model for Bow\hat{ }(⅓) without stress-wave velocity: median model means model
with the median R\hat{ }2 out of 200 random training sets. (s2s = side-to-side)

| Term | Coefficient | Std error | t-value | P (T > \|t\|) | Inclusion Freq |
|---|---|---|---|---|---|
| Butt Log Intercept | 0.6159258337 | 0.01210572 | 50.879 | 0.000 | |
| Non-butt Log Intercept | 0.5721145677 | 0.00865163 | 66.128 | 0.000 | |
| Skewness of surf Area means pos. 1 | −0.0184764215 | 0.00811744 | −2.276 | 0.025 | 0.070 |
| Real fft divergence freq 2 | 0.0155939311 | 0.00689258 | 2.262 | 0.026 | 0.875 |
| 2nd eigenvalue of pith | 0.0295867023 | 0.00919818 | 3.217 | 0.002 | 0.835 |
| Pos. 4 kurtosis surf angle diffs | −0.0534952835 | 0.01346223 | −3.974 | 0.000 | 0.640 |
| Real fft cos angle freq 9 | −0.0199376187 | 0.00736949 | −2.705 | 0.008 | 0.060 |
| Pos. 45 kurtosis box surf area | −0.2212093714 | 0.04610651 | −4.798 | 0.000 | 0.700 |
| Real fft divergence freq 1 | 0.0198933619 | 0.00906370 | 2.195 | 0.031 | 0.150 |
| Pos. 46 kurtoisis box surf area | 0.1330641241 | 0.03487919 | 3.815 | 0.000 | 0.490 |
| 2nd eigenvalue of cylinder resids | −0.0344933741 | 0.01476102 | −2.337 | 0.022 | 0.105 |
| Std of stds s2s diff shape | −0.0647910446 | 0.02560001 | −2.531 | 0.013 | 0.295 |
| Pos. 44 kurtosis box surf area | 0.1055801516 | 0.02450890 | 4.308 | 0.000 | 0.600 |
| Pos. 58 std of surf angle diffs | 0.0271749426 | 0.00787835 | 3.449 | 0.001 | 0.700 |
| Pos. 48 kurtosis box surf area | −0.0356754765 | 0.01359776 | −2.624 | 0.010 | 0.480 |
| Std of mean s2s diff shape | 0.0844355927 | 0.02384503 | 3.541 | 0.001 | 0.450 |
| Pos. 40 std normal box surf area | −0.0218324765 | 0.00867030 | −2.518 | 0.013 | 0.175 |
| Imag fft cos angle freq 1 | 0.0147094502 | 0.00554554 | 2.652 | 0.009 | 0.760 |
| Pos. 16 skew of largest box vol. | 0.0281875020 | 0.00902284 | 3.124 | 0.002 | 0.130 |
| Kurtosis of stds largest box vol. | −0.0155367273 | 0.00429818 | −3.615 | 0.000 | 0.250 |
| Pos. 3 Kurt of box surf area | 0.0539805537 | 0.01324410 | 4.076 | 0.000 | 0.275 |

Statistics
Num. Obs. = 115
Model df = 21
Error df = 94
MSE = 0.00327346
Root MSE = 0.05721415
R\hat{ }2 = 0.607
R\hat{ }2 adj. = 0.524
Test Set R\hat{ }2 = 0.395

TABLE 8
Median Model for Bow With Stress Wave Velocity
Median Model for Bow\hat{ }(⅓) with stress-wave velocity: median model means model with
the median R\hat{ }2 out of 200 random training sets. (s2s = side-to-side)

| Term | Coefficient | Std error | t-value | P (T > \|t\|) | Inclusion Freq |
|---|---|---|---|---|---|
| Butt Log Intercept | 0.6364324484 | 0.02905765 | 21.902 | 0.000 | |
| Non-butt Log Intercept | 0.5930717340 | 0.03045016 | 19.477 | 0.000 | |
| Stress Wave Velocity | −0.0086671276 | 0.01082429 | −0.801 | 0.425 | |
| 2nd eigenvalue of pith | 0.0327602991 | 0.00743642 | 4.405 | 0.000 | 0.710 |
| Imag fft divergence freq 8 | 0.0162974690 | 0.00717229 | 2.272 | 0.025 | 0.120 |
| Pos. 28 skew norm surf area | 0.0285412854 | 0.00866480 | 3.294 | 0.001 | 0.740 |
| Pos. 45 kurt box surf area | −0.1798857555 | 0.04340643 | −4.144 | 0.000 | 0.620 |
| Skew kurts s2s diff shape | 0.0104377281 | 0.00494870 | 2.109 | 0.038 | 0.380 |
| Real fft curl freq 1 | 0.0188067226 | 0.00787365 | 2.389 | 0.019 | 0.245 |
| Pos. 43 mean norm box vol smooth | −0.2519887912 | 0.07958602 | −3.166 | 0.002 | 0.440 |
| 2nd eigenvalue cyl resides | −0.0344708315 | 0.01205104 | −2.860 | 0.005 | 0.215 |
| Pos. 46 kurt box surf area | 0.1087156293 | 0.03191768 | 3.406 | 0.001 | 0.485 |
| Real fft divergence freq 7 | −0.0129605739 | 0.00603193 | −2.149 | 0.034 | 0.440 |
| Pos. 44 kurt box surf area | 0.0941491096 | 0.02411225 | 3.905 | 0.000 | 0.585 |
| Pos. 23 skew box surf area smooth | −0.0311084889 | 0.00972323 | −3.199 | 0.002 | 0.510 |
| Pos. 58 std surf angle diff smooth | 0.0205623723 | 0.00722398 | 2.846 | 0.005 | 0.585 |
| Pos. 27 kurt norm box vol smooth | −0.0278494824 | 0.00774782 | −3.594 | 0.001 | 0.800 |
| Std means s2s diff shape smooth | 0.0275493906 | 0.01193048 | 2.309 | 0.023 | 0.320 |
| Pos. 42 mean norm box vol smooth | 0.1600390341 | 0.05810664 | 2.754 | 0.007 | 0.385 |
| Pos. 46 mean norm box vol smooth | 0.1082916691 | 0.03810843 | 2.842 | 0.006 | 0.380 |
| Pos. 48 kurtosis box surf area | −0.0499117819 | 0.01519207 | −3.285 | 0.001 | 0.495 |

Statistics
Num. Obs. = 115
Model df = 21
Error df = 94
MSE = 0.00333122
Root MSE = 0.05771674
R\hat{ }2 = 0.626
R\hat{ }2 adj. = 0.547
Test Set R\hat{ }2 = 0.41

FIGS. 13 and 14 show graphs depicting the fit of the predicted bow based on the log data versus the observed bow based on the lumber data. FIG. 13 uses the model shown in Table 7 which includes stress wave velocity and FIG. 14 uses the model shown in Table 8 which does not include stress wave velocity.

### Example Models for Predicting Crook

A number of different models were used to predict bow of the lumber sawn from the sampled logs. Tables 9 and 10 show two examples of models for predicting crook; however, these are merely illustrative and the disclosure should not be limited to models including only these geometric statistics.

TABLE 9
Median Model for Crook Without Stress Wave Velocity
Median Model for Crook\hat{ }(⅓) without stress-wave velocity: median model means model
with the median R\hat{ }2 out of 200 random training sets.

| Term | Coefficient | Std error | t-value | P (T > \|t\|) | Inclusion Freq |
|---|---|---|---|---|---|
| Butt Log Intercept | 0.8204034426 | 0.01902675 | 43.118 | 0.000 | |
| Non-butt Log Intercept | 0.6662869804 | 0.01661402 | 40.104 | 0.000 | |
| Skewness box surf area means | 0.0316923075 | 0.01376649 | 2.302 | 0.024 | 0.410 |
| Pos. 4 kurt surf ang diff smooth | −0.0669257916 | 0.02003631 | −3.340 | 0.001 | 0.270 |
| Pos. 38 stds norm box surf area | −0.0341723818 | 0.01515082 | −2.255 | 0.026 | 0.840 |
| Imag fft divergence freq 8 | −0.0398062864 | 0.01122083 | −3.548 | 0.001 | 0.480 |
| Pos. 46 kurt norm box vol smooth | −0.0661235147 | 0.01385034 | −4.774 | 0.000 | 0.860 |
| Pos. 6 stds norm box surf area smooth | −0.0824658704 | 0.01959933 | −4.208 | 0.000 | 0.740 |
| Pos. 2 kurt surf ang diff smooth | 0.0607536453 | 0.01977422 | 3.072 | 0.003 | 0.285 |
| Pos. 3 skew diff box vol smooth | 0.0615676321 | 0.01704237 | 3.613 | 0.000 | 0.980 |
| 2nd eigenvalue of cyl resid | 0.1327054257 | 0.02673050 | 4.965 | 0.000 | 0.420 |
| Pos. 59 stds norm box surf area smooth | 0.1143716314 | 0.02498614 | 4.577 | 0.000 | 0.755 |
| Pos. 30 kurt surf ang diff | 0.0362627664 | 0.01290267 | 2.810 | 0.006 | 0.465 |
| Pos. 57 stds box surf area smooth | −0.1272449280 | 0.02849591 | −4.465 | 0.000 | 0.415 |
| Skew box surf area stds | −0.0241810187 | 0.01174587 | −2.059 | 0.042 | 0.410 |
| 2nd eigenval straight cyl res | −0.0630529907 | 0.01951022 | −3.232 | 0.002 | 0.375 |
| Imag fft cos angle freq 7 | −0.0611036316 | 0.01449908 | −4.214 | 0.000 | 0.990 |
| Pos. 30 std surf ang diff smooth | 0.0510545723 | 0.01607667 | 3.176 | 0.002 | 0.160 |
| Pos. 42 mean norm box vol smooth | 0.0269455506 | 0.00943909 | 2.855 | 0.005 | 0.200 |
| Pos. 28 mean surf ang diff | −0.0299797942 | 0.00685646 | −4.372 | 0.000 | 0.750 |

Statistics
Num. Obs. = 115
Model df = 20
Error df = 95
MSE = 0.01080337
Root MSE = 0.10393925
R\hat{ }2 = 0.665
R\hat{ }2 adj. = 0.598
Test Set R\hat{ }2 = 0.442

TABLE 10
Median Model for Crook With Stress Wave Velocity
Median Model for Crook\hat{ }(⅓) with stress-wave velocity: median model means model
with the median R\hat{ }2 out of 200 random training sets.

| Term | Coefficient | Std error | t-value | P (T > \|t\|) | Inclusion Freq |
|---|---|---|---|---|---|
| Butt Log Intercept | 0.8389702233 | 0.04030858 | 20.814 | 0.000 | |
| Non-butt Log Intercept | 0.8161780588 | 0.04964772 | 16.439 | 0.000 | |
| Stress Wave Velocity | −0.0468680748 | 0.01672073 | −2.803 | 0.006 | |
| Pos. 38 stds norm box surf area | −0.1203466769 | 0.02989781 | −4.025 | 0.000 | 0.945 |
| Pos. 4 kurt surf ang diff | −0.0345795097 | 0.01064949 | −3.247 | 0.002 | 0.970 |
| 2nd eigenvalue of pith | 0.0715323854 | 0.01887590 | 3.790 | 0.000 | 0.700 |
| Pos. 36 stds norm box surf area | 0.1060850880 | 0.03423338 | 3.099 | 0.003 | 0.425 |
| Pos. 46 kurt norm box vol | −0.0420054643 | 0.01173296 | −3.580 | 0.001 | 0.470 |
| Real fft curl freq 1 | 0.0356332561 | 0.01059341 | 3.364 | 0.001 | 0.660 |
| Real fft divergence freq 2 | 0.0231654788 | 0.00983157 | 2.356 | 0.020 | 0.305 |
| Skew of total angular displace | 0.0425203852 | 0.01431467 | 2.970 | 0.004 | 0.665 |
| Imag fft cos angle freq 7 | −0.0400220862 | 0.01262488 | −3.170 | 0.002 | 0.800 |
| Real fft curl freq 0 | −0.0689209162 | 0.02738645 | −2.517 | 0.013 | 0.435 |
| Pos. 33 kurt norm box surf area | 0.0426268802 | 0.01248113 | 3.415 | 0.001 | 0.925 |
| Pos. 30 kurt surf ang diff | 0.0246514695 | 0.01143010 | 2.157 | 0.033 | 0.165 |
| Pos. 3 skew box vol | 0.0666839980 | 0.01489926 | 4.476 | 0.000 | 0.935 |
| Skew surf ang diff means | −0.0339491932 | 0.01116294 | −3.041 | 0.003 | 0.635 |

Statistics
Num. Obs. = 115
Model df = 17
Error df = 98
MSE = 0.00907114
Root MSE = 0.09524254
R\hat{ }2 = 0.647
R\hat{ }2 adj. = 0.59
Test Set R\hat{ }2 = 0.522

FIGS. 15 and 16 show graphs depicting the fit of the predicted crook based on the log data versus the observed crook based on the lumber data. FIG. 15 uses the model shown in Table 9 which includes stress wave velocity and FIG. 16 uses the model shown in Table 10 which does not include stress wave velocity.

### Example Models for Predicting Twist

A number of different models were used to predict bow of the lumber sawn from the sampled logs. Tables 11 and 12 show two examples of models for predicting twist; however, these are merely illustrative and the disclosure should not be limited to models including only these geometric statistics.

TABLE 11
Median Model for Twist Without Spiral Grain Angle
Median Model for Abs (Twist) without spiral grain angle: median model means model
with the median R\hat{ }2 out of 200 random training sets. (s2s = side-to-side)

| Term | Coefficient | Std error | t-value | P (T > \|t\|) | Inclusion Freq |
|---|---|---|---|---|---|
| Butt Log Intercept | 0.1052636140 | 0.01176100 | 8.950 | 0.000 | |
| Non-butt Log Intercept | 0.1826058497 | 0.01092937 | 16.708 | 0.000 | |
| 3rd spectral peak angle | −0.0207568960 | 0.00749158 | −2.771 | 0.007 | 0.960 |
| Pos. 3 std surf ang diff | 0.0598968368 | 0.01391451 | 4.305 | 0.000 | 0.780 |
| Pos. 35 mean box vol smooth | −0.0521801651 | 0.02597414 | −2.009 | 0.047 | 0.230 |
| Real fft cos angle freq 3 | −0.0196770925 | 0.00680497 | −2.892 | 0.005 | 0.115 |
| Pos. 32 mean box vol smooth | 0.1180627573 | 0.04996074 | 2.363 | 0.020 | 0.210 |
| Pos. 59 std s2s diff shape | 0.2116883240 | 0.08082073 | 2.619 | 0.010 | 0.575 |
| Pos. 31 mean box vol smooth | −0.0684778805 | 0.03274118 | −2.091 | 0.039 | 0.140 |
| Pos. 58 std s2s diff shape | −0.1634161956 | 0.06285787 | −2.600 | 0.011 | 0.630 |
| Pos. 62 std s2s diff shape | −0.0507066068 | 0.01874786 | −2.705 | 0.008 | 0.300 |
| Mean ridge angle | 0.0230928097 | 0.00917700 | 2.516 | 0.013 | 0.690 |
| Min(dist neighbor 0 180 sep) | −0.0420838246 | 0.01429220 | −2.945 | 0.004 | 0.200 |
| Std of std of curl around log | −0.0488206839 | 0.01603872 | −3.044 | 0.003 | 0.335 |
| Dcr vrgm-dst vrgm lag 4 | −0.0025652262 | 0.00126107 | −2.034 | 0.045 | 0.295 |
| Pos. 57 std surf ang diff smooth | 0.0168094862 | 0.00725541 | 2.317 | 0.023 | 0.340 |

Statistics
Num. Obs. = 115
Model df = 16
Error df = 99
MSE = 0.00476415
Root MSE = 0.06902280
R\hat{ }2 = 0.657
R\hat{ }2 adj. = 0.605
Test Set R\hat{ }2 = 0.531

TABLE 12
Median Model for Twist With Spiral Grain Angle
Median Model for Abs (Twist) with spiral grain angle: median model means model with
the median R\hat{ }2 out of 200 random training sets. (s2s = side-to-side)

| | | | | | Inclusion |
|---|---|---|---|---|---|
| Term | Coefficient | Std error | t-value | P (T > \|t\|) | Frequency |
| Butt Log Intercept | 0.0834757391 | 0.00969573 | 8.610 | 0.000 | |
| Non-butt Log Intercept | 0.1334367222 | 0.00970346 | 13.751 | 0.000 | |
| Spiral Grain Angle | 0.0185237973 | 0.00295049 | 6.278 | 0.000 | |
| 3rd spectral peak angle | −0.0166203933 | 0.00690539 | −2.407 | 0.018 | 0.815 |
| Hcr vrgm-hsh vrgm lag 63 | 0.3891008037 | 0.09307241 | 4.181 | 0.000 | 0.905 |
| Pos. 61 std s2s diff shape | −0.0715000004 | 0.02828653 | −2.528 | 0.013 | 0.470 |
| Std of std div around log | −0.0231231975 | 0.00948578 | −2.438 | 0.017 | 0.635 |
| Pos. 60 std s2s diff shape | 0.0764134730 | 0.03219960 | 2.373 | 0.020 | 0.245 |
| Pos. 3 std surf ang diff | 0.0529847523 | 0.00967603 | 5.476 | 0.000 | 0.610 |
| Min(ang neighbor 3 90 sep) | 0.0238926180 | 0.00563262 | 4.242 | 0.000 | 0.265 |
| Imag fft divergence freq 9 | 0.0122198892 | 0.00558267 | 2.189 | 0.031 | 0.260 |
| Min(ang neighbor 2 90 sep) | 0.1651973082 | 0.05284632 | 3.126 | 0.002 | 0.385 |
| Kurt norm box vol stds smooth | 0.0134766619 | 0.00397650 | 3.389 | 0.001 | 0.530 |
| Real fft curl freq 2 | −0.0245035193 | 0.00567251 | −4.320 | 0.000 | 0.720 |
| Hcr vrgm-hsh vrgm lag 62 | −0.3864168277 | 0.09293354 | −4.158 | 0.000 | 0.910 |
| Min(ang neighbor 0 180 sep) | −0.1555827511 | 0.05325462 | −2.921 | 0.004 | 0.350 |
| Imag fft curl freq 1 | −0.0212837469 | 0.00708376 | −3.005 | 0.003 | 0.355 |
| Imag fft curl freq 9 | 0.0234293771 | 0.00544588 | 4.302 | 0.000 | 0.470 |

Statistics
Num. Obs. = 115
Model df = 18
Error df = 97
MSE = 0.00276164
Root MSE = 0.05255132
R\hat{ }2 = 0.785
R\hat{ }2 adj. = 0.747
Test Set R\hat{ }2 = 0.75

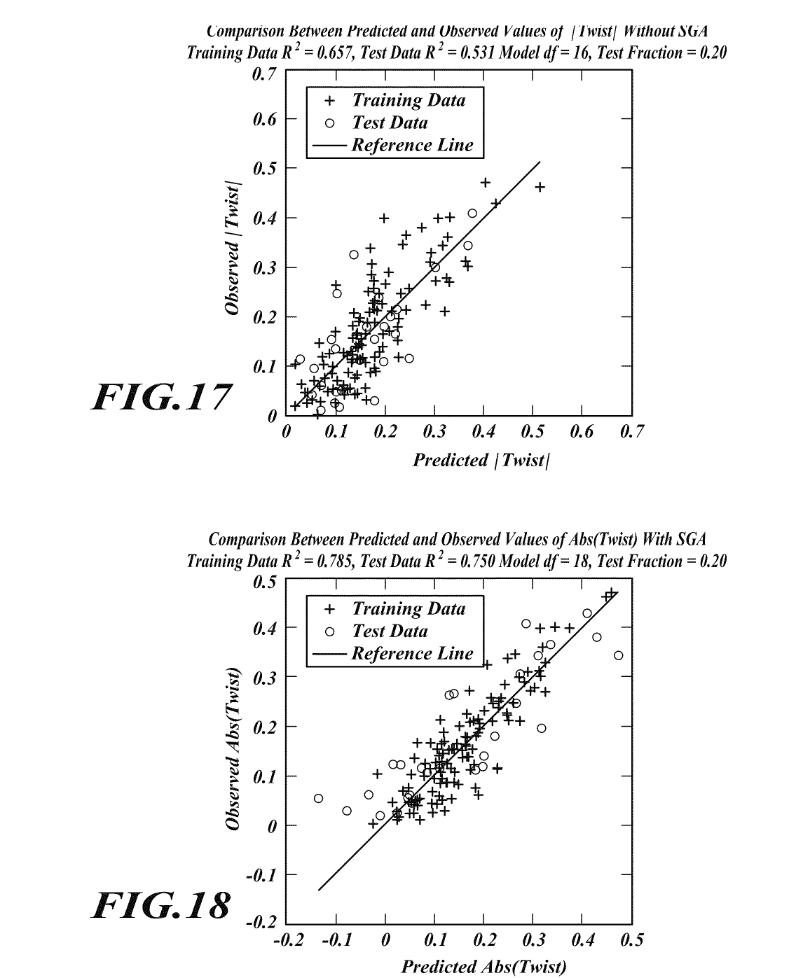

FIGS. 17 and 18 show graphs depicting the fit of the predicted twist based on the log data versus the observed bow based on the lumber data. FIG. 17 uses the model shown in Table 11 which includes spiral grain angle and FIG. 18 uses the model shown in Table 12 which does not include spiral grain angle.

### Example 2

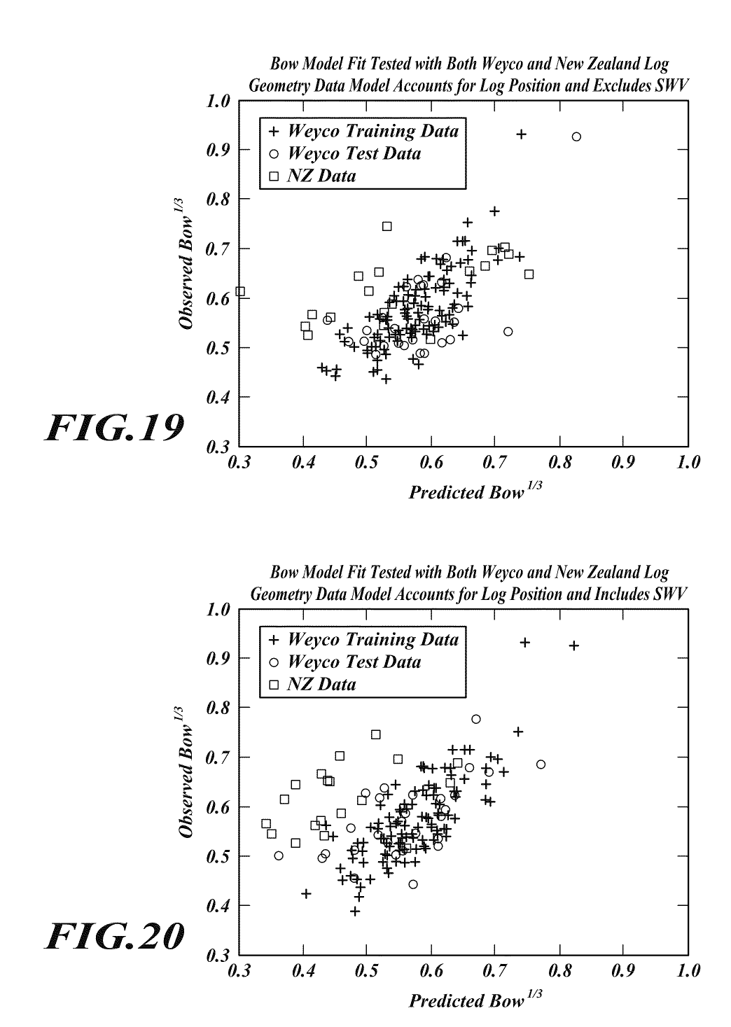

The models from Tables 7 and 8 were used to predict bow for 19 Radiata Pine logs. The actual bow of lumber from the Radiata Pine logs was then measured and compared with the bow predicted by the model. FIGS. 19 and 20 shows graphs using data from both the Loblolly Pine logs and the Radiata Pine logs. FIG. 19 shows a graph depicting the fit of the predicted bow using the model in Table 7 versus the observed bow based on the lumber data. FIG. 20 shows a graph depicting the fit of the predicted bow using the model in Table 8 versus the observed bow based on the lumber data. The New Zealand data was offset from the US data, but is parallel to it. The offset indicates that models for predicting warp propensity according to the disclosure are likely to be species and age dependent.

I/We claim:

1. A method for predicting warp of a wood product produced from a log, the method comprising:
performing a three dimensional scan of the log to obtain geometric data;
using the geometric data to construct a log profile;
deriving geometric statistics from the one or more residual grid profiles or from the log profile; and
entering the geometric statistics into a model for predicting warp of the wood product;
wherein the geometric statistics comprise orientation dependent statistics.

2. The method for predicting warp in claim 1 further comprising:
partitioning the geometric data into geometric components and removing one or more selected geometric components to create one or more residual grid profiles.

3. The method of claim 1 wherein the geometric statistics further comprise orientation independent statistics.

4. The method of claim 1 wherein the one or more selected geometric components relate to the log's main cylindrical shape, the log's swept and bent shape, the log's taper, or the log 's surface lumpiness.

5. The method of claim 1 wherein the model for predicting warp utilizes additional measurements selected from the group consisting of ultra sound measurements, spiral grain angle measurements, stress wave velocity measurements, multimode resonance measurements, branch location and size measurements, measurements of ring patterns on log ends, measurements indicating evidence or severity of compression wood on log ends, moisture content measurements, weight measurements, and density measurements.

6. The method of claim 1 wherein the wood product is lumber and the warp is selected from the group consisting of bow, crook, cup, and twist.

7. The method of claim 1 wherein the model for predicting warp is partially based on whether selected geometric statistics are uniform over the log's surface.

8. The method of claim 1 wherein the step of performing a three dimensional scan of the log to obtain geometric data is performed before a bucking system, at the bucking system, at a merchandiser, or at a primary breakdown system.

9. A method for predicting warp of a wood product produced from a second log based on scanning a first log, the method comprising:
creating a model for predicting warp partially based on the first log's surface geometry by:
performing a three dimensional scan of a first log to obtain first geometric data;
subtracting a reference cylinder from the first geometric data to obtain cylinder residual data;
calculating a mathematical center for the cylindrical residual data;
subtracting the mathematical center from cylindrical residual data to obtain straightened cylindrical residual data;
removing variation due to taper from the cylindrical residual data to obtain pure structure data;
deriving a plurality of first statistics from the first geometric data, the cylindrical residual data, the straightened cylindrical residual data, or the pure structure data; and
correlating the first plurality of statistics with warp potential of lumber or veneer to be produced from the first log;
performing a three-dimensional scan of the second log to obtain second geometric data;
calculating second geometric statistics from the second geometric data;
inputting the second geometric statistics into the model to predict the warp potential of lumber or veneer to be produced from the second log.

10. The method of claim 9 wherein the model for predicting warp is also based on additional measurements selected from the group consisting of ultra sound measurements, spiral grain angle measurements, stress wave velocity measurements, multimode resonance measurements, branch location and size measurements, measurements of ring patterns on log ends, measurements indicating evidence or severity of compression wood on log ends, moisture content measurements, weight measurements, and density measurements.

11. The method of claim 9 wherein the model for predicting warp is partially based on whether selected geometric statistics are uniform over the log's surface.

12. The method of claim 9 wherein the steps of performing a three dimensional scan of the first log and performing a three dimensional scan of the second log are performed before a bucking system, at the bucking system, at a merchandiser, or at a primary breakdown system.

13. A method for predicting warp of a wood product produced from a log, the method comprising:
performing a three dimensional scan of the log to obtain geometric data relating to the log's surface;
partitioning the geometric data into one or more geometric components;
removing the one or more geometric components from the geometric data to generate one or more residual grid profiles;
deriving geometric statistics from the residual grid profiles or the log profile data; and
predicting warp of the wood product based on the geometric statistics.

14. The method of claim 13 wherein the geometric statistics are orientation dependent statistics or orientation independent statistics.

15. The method of claim 13 wherein the step of performing the three-dimensional scan of the log is done before a bucking at the bucking system, at a primary breakdown system, or at a merchandiser.

16. The method of claim 13 wherein the warp is selected from the group consisting of bow, crook, cup, and twist.

17. The method of claim 13 wherein the geometric statistics comprise circumferential positions, means, standard deviations, coefficients of skewness and kurtosis of point-to-point distances along the log.

18. The method of claim 13 wherein the geometric components relate to a reference cylinder, a numerical pith of the log, or a taper function of the log.

19. The method of claim 13 wherein the step of predicting warp is also based on additional measurements selected from the group consisting of ultra sound measurements, spiral grain angle measurements, stress wave velocity measurements, multimode resonance measurements, branch location and size measurements, measurements of ring patterns on log ends, measurements indicating evidence or severity of compression wood on log ends, moisture content measurements, weight measurements, and density measurements.

20. The method of claim 13 wherein the wood product is selected from the group consisting of lumber, veneer products, or wood strand products.
